(19) United States
(12) Patent Application Publication
(10) Pub. No.: US 2024/0181382 A1
(43) Pub. Date: Jun. 6, 2024

(54) GAS TREATMENT SYSTEM, GAS TREATMENT METHOD AND CONTROL DEVICE

(71) Applicant: SyncMOF Inc., Aichi (JP)

(72) Inventors: Akihiro HORI, Aichi (JP); Junichi HATAOKA, Aichi (JP)

(21) Appl. No.: 17/781,242

(22) PCT Filed: Mar. 31, 2022
(86) PCT No.: PCT/JP2022/016857

§ 371 Date: May 31, 2022

(30) Foreign Application Priority Data
Apr. 28, 2021 (JP) 2021-075478

(51) Int. Cl. B01D 53/04; B01J 20/22

(52) U.S. Cl. CPC B01D 53/0446; B01D 53/0454; B01J 20/226; B01D 2253/204; B01D 2259/402

(57) ABSTRACT

To realize easy management of gas residual amount while reducing the burden on gas users, the gas treatment system 1 according to an embodiment of the present disclosure includes a first container 5A1 that houses a first porous metal-organic framework capable of collecting a first gas contained in a mixed gas flowing from an inlet side, a second container 5B1 that houses a second porous metal-organic framework capable of collecting a second gas contained in the mixed gas that flows in series with the first container 5A1, a first gas detector TCD11 that is provided as a detection target in a space of the flow path on the downstream side of the first container 5A1 and can detect the first gas, and a control device 100 that outputs at least information on the state of the first container 5A1 based on the detection information based on the first gas detector.

### TECHNICAL FIELD

The present invention relates to a gas treatment system, a gas treatment method and a control device thereof.

### BACKGROUND ART

A technique for separating or filtering only a desired gas from a mixed gas containing a plurality of types of gases are being developed. For example, Patent Literature 1 below discloses a technique for recovering carbon monoxide from a weight loss gas using zeolite.

### PRIOR ART

### Patent Literature

[Patent Literature 1] Japanese Unexamined Patent Application Publication No. 2013-170102

### SUMMARY OF THE INVENTION

### Technical Problem

Since the technique disclosed in Patent Literature 1 requires a gas purification step, the apparatus tends to be large in size and is not convenient for gas users.

Therefore, the present disclosure has been made in view of the above problems, and an object thereof is to provide a gas treatment system, a gas treatment method, and a control device thereof that can easily obtain a desired gas from a mixed gas by a gas user.

### Technical Solution

According to the present disclosure, there is provided a gas treatment system comprising: a first container that houses a first porous metal-organic framework capable of collecting a first gas contained in a mixed gas flowing from an inlet side; a second container that houses a second porous metal-organic framework capable of collecting a second gas contained in the mixed gas that flows in series with the first container; a first gas detector that is provided in the space of the flow path on the downstream side of the first container as a detection target and can detect the first gas; and a control device that outputs at least information concerning the state of the first container based on the detection information based on the first gas detector.

Also, according to the present disclosure, there is provided a gas treatment system comprising: a first container that houses a first porous metal-organic framework capable of collecting a first gas contained in a mixed gas flowing from an inlet side; and a second container that houses a second porous metal-organic framework capable of collecting a second gas contained in the mixed gas flowing from an outlet side of the first container, wherein the housing capacity of the first porous metal-organic framework in the first container and the housing capacity of the second porous metal-organic framework in the second container are set according to the composition ratio of the first gas and the second gas contained in the mixed gas.

Further, according to the present disclosure, there is provided a gas treatment method using a gas treatment device which comprises a first container that houses a first porous metal-organic framework capable of collecting a first gas; and a second container that flows in series with the first container and houses a second porous metal-organic framework capable of collecting a second gas, the method comprising the steps of: flowing a mixed gas containing at least the first gas and the second gas from an inlet side of the container on the upstream side of either the first container or the second container; measuring the flow rate of the first gas in the space of the flow path on the downstream side of the first container by a first gas detector; and outputting information concerning the state of the first container by a control device, based on the detection information obtained based on the flow rate of the first gas measured by the first gas detector.

Further, according to the present disclosure, there is provided a gas treatment method using a gas treatment device which comprises a first container that houses a first porous metal-organic framework capable of collecting a first gas; and a second container that flows with the first container and houses a second porous metal-organic framework capable of collecting a second gas, the method comprising the steps of: setting the housing capacity of the first porous metal-organic framework in the first container and the housing capacity of the second porous metal-organic framework in the second container according to the composition ratio of the first gas and the second gas contained in the mixed gas; and allowing the mixed gas to flow from an inlet side of the first container.

Further, according to the present disclosure, there is provided a control device comprising: a first container that houses a first porous metal-organic framework capable of collecting a first gas; and a second container that flows in series with the first container and houses a second porous metal-organic framework capable of collecting a second gas, wherein after the mixed gas that houses at least the first gas and the second gas, which is circulated from an inlet side of the first container, is circulated to the first container, the space of the downstream side flow path of the first container is provided as a detection target, and information concerning the status of the first container is outputted based on the detection information obtained from the first gas detector capable of detecting the first gas.

### Advantageous Effects

According to the present invention, a gas user can easily obtain a desired gas from a mixed gas.

### BRIEF DESCRIPTION OF THE DRAWINGS

FIG. 1 is a diagram showing an outline of a gas treatment system 1 according to an embodiment of the present disclosure.

FIG. 2 is a diagram showing a system configuration example of the gas treatment system 1 according to the present embodiment.

FIG. 3 is a diagram showing a hardware configuration example of a computer that realizes the control device 100 according to the present embodiment.

FIG. 4 is a flowchart showing an example of a flow of a gas treatment method using the gas treatment system 1 according to the present embodiment.

FIG. 5 is a diagram showing a system configuration example of the gas treatment system 1′ according to the first modification of the present embodiment.

FIG. 6 is a diagram showing a system configuration example of the gas treatment system 1′ according to the second modification of the present embodiment.

FIG. 7 is a diagram showing a system configuration example of a gas treatment system 1′″ according to the third modification of the present embodiment.

FIG. 8 is a diagram showing a system configuration example of the gas treatment system 1000 according to the fourth modification of the present embodiment.

### DETAILED DESCRIPTION OF THE EMBODIMENTS

Preferred embodiments of the present disclosure will be described in detail below with reference to the accompanying drawings. Further, in the present specification and the drawings, components having substantially the same functional configuration are designated by the same reference numerals, so that duplicate description will be omitted.

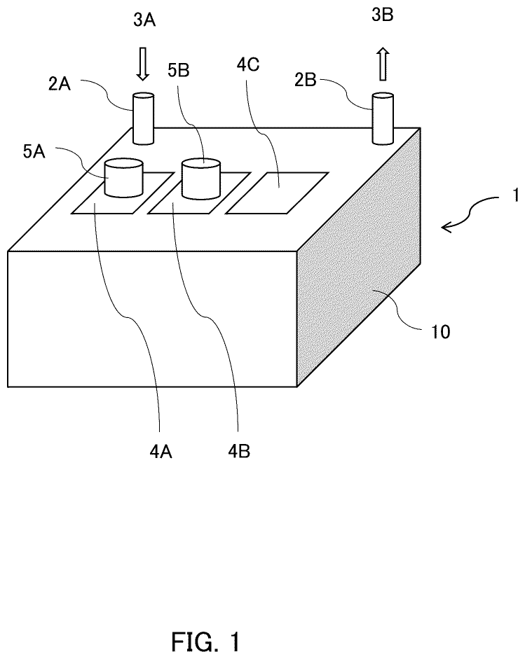

FIG. 1 is a diagram showing an outline of a gas treatment system 1 according to an embodiment of the present disclosure. As shown in the figure, the gas treatment system 1 according to the present embodiment includes a housing 10. The size and shape of the housing 10 are not particularly limited. For example, the housing 10 may have the shape of a substantially cube or a substantially rectangular parallelepiped whose one side is about several tens of mm to several thousand mm. That is, the housing 10 may have a size capable of being carried. Further, the housing 10 may have a cylindrical shape or the like. Further, the housing 10 may be installed in equipment or the like. In the present embodiment, the housing 10 is a portable housing. The housing 10 has an inlet port 2A for gas 3A, an outlet port 2B for gas 3B, a mounting port 4 (4A, 4B, 4C) for mounting and detaching a container 5 (5A, 5B, etc.), and a container 5. The gas 3A introduced from the inlet port 2A passes through the container 5 mounted on the mounting port 4 and is led out as the gas 3B from the outlet port 2B. When a plurality of containers 5 are provided, the flow paths of the plurality of containers 5 may be connected in series or may be connected in parallel. That is, in the example shown in FIG. 1, the inlet port 2A may be connected only to the container 5A, the container 5B may be connected to the container 5A, and the container 5B may be connected only to the outlet port 2B. The inlet port 2A and the outlet port 2B may be connected to both the container 5A and the container 5B. Further, the present technique is not limited to the configuration shown in FIG. 1. For example, the number of mounting ports 4 for mounting the container 5 is not limited, and the number of the containers 5 is not limited accordingly. Further, a plurality of containers 5 may be mounted in one mounting port 4. Further, the container 5 may be stored inside the housing 10.

The container 5 houses a porous metal-organic framework (MOF/PCP: Metal Organic Framework/Porous Coordination Polymer) therein. MOF (hereinafter, MOF/PCP is also simply referred to as MOF) is a complex having a continuous structure consisting of a metal ion and an organic molecule of a polydentate ligand. The MOF has a three-dimensional continuous coordination structure and forms a nanoporous structure. Depending on the combination of metal ions and organic molecules, MOF can adsorb only specific substances. That is, when a gas containing a specific substance is introduced into the container containing the MOF, the gas composed of the specific substance can be collected in the container. For example, the container 5A may contain a MOF capable of collecting a gas composed of a substance XX, and the container 5B may contain a MOF capable of collecting a gas composed of a substance YY different from the substance XX. Thereby, the substance XX and the substance YY can be obtained by isolation in each container 5. That is, for example, if the container 5 is provided with one type of MOF, the container 5 can collect one type of gas. The container 5A and the container 5B may contain a MOF capable of collecting a gas composed of the same substance. Further, the container 5 may contain a plurality of types of MOFs. Examples of the types of substances constituting the gas will be described later.

Further, the specification of the container 5 is not particularly limited as long as the MOF can be housed and a gas inlet port and outlet port are provided. For example, the container 5 may be a general high-pressure cylinder or the like specified in JIS standards, ISO standards, or the like. Further, the container 5 may not be a high-pressure cylinder, and may be a container having a pressure resistance of less than 1 MPa. That is, since the gas is physically adsorbed to the MOF by housing the MOF, the pressure resistance performance of the container is not particularly limited. The size and shape of the container 5 are also not particularly limited. The container 5 according to the present embodiment is a portable container. The container 5 may be stored, for example, by a housing or the like. In this case, the shape of the housing may be determined according to the shape of the container 5, or the shape of the container 5 may be determined according to the shape of the housing. The shape of the container 5 may be a cylinder, a cube, or a rectangular parallelepiped, and is not particularly limited. Further, the container 5 may be provided with an arbitrary vent system. Further, as will be described later, the container 5 may be provided with a pressure sensor (pressure gauge) for measuring the pressure inside the container 5, a temperature sensor for measuring the temperature around or inside the container 5, and the like. These pressure sensor and temperature sensor may be attached to the on-off valve of the container 5 or may be attached in advance to the container 5, for example, as will be described later. Such measurement information may be appropriately transmitted to an external server or the like by a communication device or the like provided in the container 5 or the housing 10, and may be stored in a storage device such as a flash memory provided in the container 5 or the housing 10. Further, in such external servers and storage devices, information concerning the container 5 (e.g., the specification of the container 5, the identification information of the container 5, information concerning maintenance of the container 5, information concerning the manager of the container 5, information concerning the user of container 5, information concerning the temperature inside the container 5, the housing 10 to which the container 5 is attached, information concerning the mounting port 4 to which the container 5 is attached in the housing 10), and/or information concerning the MOF housed in the container 5 and the gas that can be collected by the MOF (e.g., the type of the MOF, information concerning the use of the MOF, information concerning the deterioration of the MOF, information concerning the types of gas collected, information concerning the amount of gas stored, gas filling amount, gas pressure, etc.) may be stored. For example, the user reads out the storage device provided in the container 5 or a tag such as a QR code (registered trademark) using a terminal or the like, and thus the above-mentioned information can be obtained. In this manner, even if the container 5 or the housing 10 is provided with various devices related to IoT (Internet of Things) for managing the status of the MOF housed in the container 5 and the gas adsorbed on the MOF. Examples of the devices may be, for example, a device for acquiring positional information such as GPS (Global Positioning System) function, a control device for controlling valves and the like at the inlet port or outlet port of the container 5, and a display device, etc. for displaying information concerning the container 5. The display device referred to here may be, for example, a light source such as an LED or a device such as a so-called display. In the case of a light source, for example, the state of the container 5 may be displayed according to the color of the lit light, the blink pattern, or the like.

In the present embodiment, it is assumed that a mixed gas containing a plurality of substances is introduced from the inlet port 2A, but the present technique is not limited to such an example. For example, as shown in a modification described later, a gas made of a single substance may be introduced from the inlet port 2A. Examples of the substance constituting the gas include hydrogen, oxygen, carbon monoxide, carbon dioxide, water, acetylene, NF3, CF4, CH3, propane, ethylene, ethane and the like. Of course, the substance constituting the gas to be collected is not limited to such an example. Further, the mixed gas contains at least a plurality of substances, and the number of types thereof may be 3 or more.

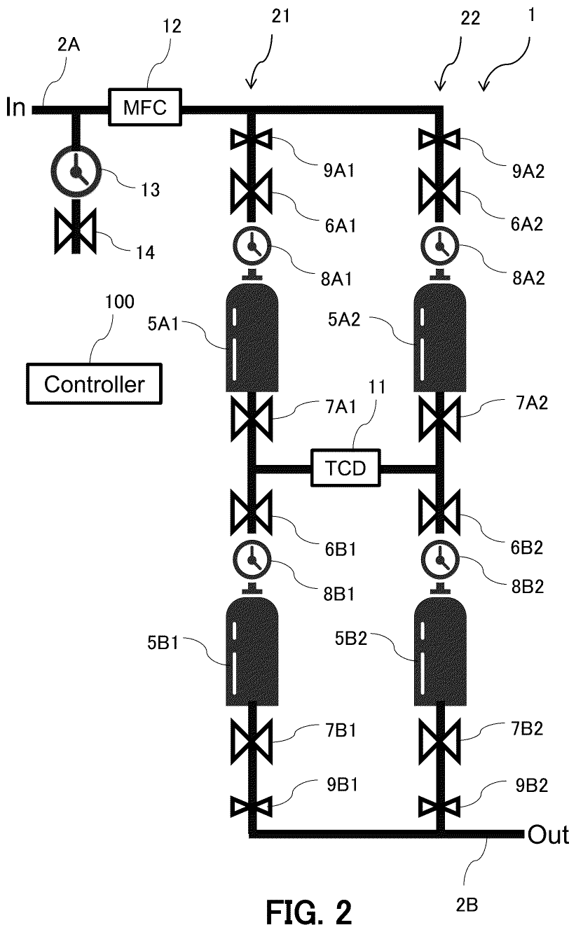

FIG. 2 is a diagram showing a system configuration example of the gas treatment system 1 according to the present embodiment. As shown in the figure, the gas treatment system 1 includes a first line 21 and a second line 22 between the inlet port 2A and the outlet port 2B. The first line 21 includes a first container 5A1 and a second container 5B1 and these containers are connected in series so that the first container 5A1 and the second container 5B1 form a series of flow paths. The first container 5A1 and the second container 5B1 are provided with an inlet valve 6 (6A1, 6B1), an outlet valve 7 (7A1, 7B1), and a pressure gauge 8 (8A1, 8B1), respectively. Further, line attaching/detaching parts 9 (9A1 and 9B1) are provided on the most upstream side and the most downstream side of the first line 21, respectively. The arrangement order of the first container 5A1 and the second container 5B1 is not particularly limited.

Further, the second line 22 provided in parallel with the first line 21 includes a third container 5A2 and a fourth container 5B2, and these containers are connected in series. The third container 5A2 and the fourth container 5B2 each include an inlet valve 6 (6A2, 6B2), an outlet valve 7 (7A2, 7B2), and a pressure gauge 8 (8A2, 8B2), respectively. Further, line attaching/detaching parts 9 (9A2, 9B2) are provided on the most upstream side and the most downstream side of the second line 22, respectively. The arrangement order of the third container 5A2 and the fourth container 5B2 is not particularly limited. Further, the pair of the inlet valve 6 and the outlet valve 7 provided in each of the first line 21 and the second line 22, respectively, is also collectively referred to as a valve unit. Further, in the following description, the first container 5A1 and the third container 5A2 are collectively referred to as a container 5A, and the second container 5B1 and the fourth container 5B2 are collectively referred to as a container 5B. In the present embodiment, two lines of a first line 21 and a second line 22 are provided. The present technique is not limited to such examples. The number of lines provided in parallel is not particularly limited. Further, the number of containers connected in series in each line is not particularly limited. For example, it is possible to set the number of containers according to the number of types of gas to be collected. Specifically, only one container may be provided for one line. It is conceivable that only one type of gas is collected from the mixed gas.

The first container 5A1 and the third container 5A2 may house a MOF (first MOF) capable of collecting the first gas contained in the mixed gas. Further, the second container 5B1 and the fourth container 5B2 can house a MOF (second MOF) capable of collecting the second gas contained in the mixed gas. The amount of MOF contained in these containers is not particularly limited. For example, the housing capacity of the first MOF in the first container 5A1 and the housing capacity of the second MOF in the second container 5B1 may be set according to the composition ratio (material amount ratio) of the first gas and the second gas contained in the mixed gas. Thereby, since the first container 5A1 and the second container 5B1 are saturated at almost the same timing (that is, the adsorption of the substance to the MOF hardly occurs), the containers can be efficiently collected and replaced. Further, the housing capacity of the first MOF in the first container 5A1 and the housing capacity of the second MOF in the second container 5B1 may be set according to the required recovery amount in addition to the composition ratio of the gas.

Each container 5 is provided with an inlet valve 6, an outlet valve 7, and a pressure gauge 8 as described above. These valves and pressure gauges may be attached directly to the container 5 or may be attached in association with the container 5. For example, these valves and pressure gauges may be removable from the container 5 or may be provided in the vicinity of the gas inlet or outlet pipe of the container 5. The container 5 according to the present embodiment may be configured so as to include, for example, an inlet valve 6 and a pressure gauge 8. In this case, the pressure gauge 8 may be provided, for example, in the flow path connecting the inlet valve 6 and the container 5. That is, the pressure gauge 8 may be provided on the container 5 side with respect to the inlet valve 6. The pressure gauge 8 is attached to the container 5 when the container 5 is removed from the line, and is provided to measure the amount of gas stored in the container 5. Thereby, when the container 5 is removed from the housing 10 and the gas housed in the container 5 is used, it is possible to grasp the residual amount of gas and the like. Further, as described above, the container 5 may be provided with a temperature sensor or the like.

The inlet valve 6 and the outlet valve 7 are provided on the upstream side and the downstream side of the container 5, respectively. The opening and closing of these valves can be controlled, for example, by a control device 100 described later. The valve can be, for example, a solenoid valve. As mentioned above, if the inlet valve 6 and/or the outlet valve 7 is attached to the container 5, the control device 100 can control the opening and closing of the inlet valve 6 and/or the outlet valve 7 via a control device or the like provided in the container 5. Further, these valves may be manually opened and closed. The inlet valve 6 and the outlet valve 7 may be integrated. These valves may be, for example, those provided in the container 5 for carrying the gas housed in the container 5 and for other purposes. Thereby, the gas recovered in the container 5 by the gas treatment system 1 can be reused.

The line attaching/detaching part 9 is provided on the most upstream side and the most downstream side of the first line 21 and/or the second line 22, and has a mechanism capable of removing the container 5 provided in each line at once. The line attaching/detaching part 9 does not necessarily have to be provided, but due to such a configuration, for example, when the first container 5A1 and the second container 5B1 are saturated, respectively, it is easy to replace two containers at once. The line attaching/detaching part 9 can be realized, for example, by Quick-Connects made by Swagelok. A pair of such line attaching/detaching parts 9 may be provided on the upstream and downstream sides of the line, or may be provided on the upstream and downstream sides of each container. In addition, each of the containers 5 can be independently attached and detached.

A TCD (Thermal Conductivity Detector) 11 is provided between the flow paths connecting the first container 5A1 and the second container 5B1. The TCD11 is an example of a gas detector and may be replaced by other types of gas detectors such as gas chromatography. Although not shown in the figure, the TCD 11 can be connected to a flow path on the upstream side of each line as a sampling line. The TCD 11 may also be provided between the flow paths connecting the third container 5A2 and the fourth container 5B2. The TCD11 according to the present embodiment detects, for example, a first gas that can be collected by a MOF (referred to as a first MOF) housed in the first container 5A1 and/or the third container 5A2. The TCD 11 may output the detection result data (for example, an electric signal) to the control device 100 described later, or the TCD 11 may process these data and output the result processed as detection information. The detection information may be, for example, breakthrough information indicating that the first gas is breaking through. The breakthrough means a state in which the limit of adsorption by MOF is exceeded in the present embodiment. The breakthrough information is an example of detection information indicating that the gas (first gas or second gas) is breaking through. That is, as a result of the measurement by the TCD 11, whether or not the first gas is breaking through (whether or not the predetermined standard for determination of the breakthrough has been exceeded) can be obtained as detection information by the control device 100 described later.

The TCD 11 may be provided in the flow path on the downstream side of the second container 5B1 (and/or the fourth container 5B2) as shown in the modification described later. Thereby, the breakthrough of the second gas flowing out from the second container 5B1 and 5B2 can be detected. Further, the TCD 11 may be provided on at least one of the exit side of the first container 5A1 and the outlet side of the second container 5B1 as long as it is on the downstream side of the first container 5A1. Further, the TCD 11 may detect at least one of the first gas and the second gas.

Meanwhile, as described above, if the housing capacities of the first MOF housed in the first container 5A1 (and/or the third container 5A2) and the second container 5B1 (and/or the fourth container 5B2) are set according to the composition ratio of the first gas and the second gas contained in the mixed gas, the first container 5A1 and the second container 5B1 can be saturated almost at the same time. That is, the composition ratio of the first gas and the second gas in the mixed gas corresponds to the ratio of the substance adsorption amount of the MOF housed in each container, so that each container can be saturated at almost the same timing. In this case, only one TCD11 may be provided in the flow path on the downstream side of the first container 5A1 (and/or the third container 5A2). As a result, the number of TCD11s installed is reduced, and a plurality of containers arranged on the line can be replaced at one time, which is efficient. The capacity of the first MOF housed in the first container 5A1 (and/or the third container 5A2) and the capacity of the second MOF housed in the second container 5B1 (and/or the fourth container 5B2) can be appropriately set according to the composition ratio of the gas and the amount of the gas to be recovered.

An MFC (Mass Flow Controller) 12 that controls the flow rate of the gas flowing from the inlet port 2A is provided on the upstream side of the first line 21 and the second line 22. Further, a vent line is provided on the upstream side of the MFC 12, and a pressure gauge 13 and a vent valve 14 are provided on the vent line. For example, when the pressure gauge 13 measures a pressure exceeding a predetermined threshold value, the vent valve 14 is opened by controlling by the control device 100 described later, and can leak from the vent line to which gas is applied. The position where the vent line is provided is not limited to the examples shown in FIG. 2. For example, the vent line may be provided in the flow path between the MFC 12, and the first line 21 and/or the second line 22, or may be provided between the downstream side of the first line 21 and/or the second line 22 and the outlet port 2B. Further, the vent valve 14 may be such that the gas automatically leaks to the outside when a predetermined pressure is reached. Additionally, the gas treatment system 1 according to the present embodiment may not be provided with a cleaning line for purging the gas corresponding to the impurities collected in the container 5. This is because the gas treatment system 1 according to the present embodiment assumes that the gas collected in the container 5 is reused.

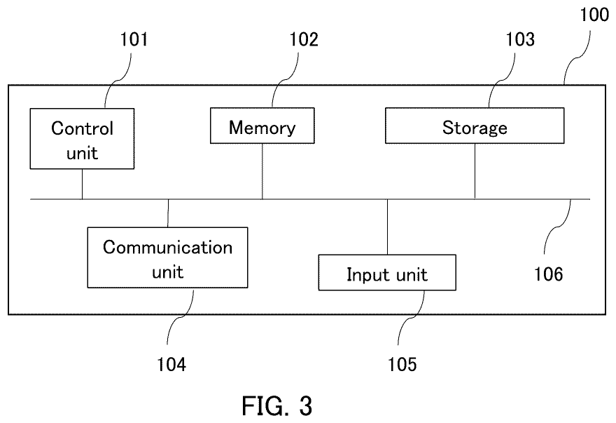

The gas treatment system 1 includes a control device 100 that controls the entire system. FIG. 3 is a diagram showing a hardware configuration example of a computer that realizes the control device 100 according to the present embodiment. The 100 includes at least a controller 101, a memory 102, a storage 103, a communication unit 104, an input/output unit 105, and the like. These are electrically connected to each other through a bus 106.

The controller 101 is an arithmetic unit that controls the operation of the entire control device 100, controls the transmission and reception of data between each element, and performs information processing necessary for application execution and authentication processing. For example, the controller 101 is a processor such as a CPU (Central Processing Unit), and executes each information processing by executing a program or the like stored in the storage 103 and deployed in the memory 102.

The memory 102 includes a main memory composed of volatile storage devices such as DRAM (Dynamic Random Access Memory), and an auxiliary storage composed of non-volatile storage devices such as flash memory or HDD (Hard Disk Drive). The memory 102 is used as a work area or the like of the controller 101, and also stores a BIOS (Basic Input/Output System) executed at the start of the control device 100, various setting information, and the like.

The storage 103 stores various programs such as application programs. A database storing data used for each process may be built in the storage 103.

The communication unit 104 connects the control device 100 to the network. The communication unit 104 communicates with an external device directly or via a network access point by a method such as, for example, a wired LAN (Local Area Network), a wireless LAN, Wi-Fi (Wireless Fidelity, registered trademark), an infrared communication, a Bluetooth (registered trademark), a short-range or non-contact communication, or the like.

The input/output unit 105 is, for example, an information input device such as a keyboard, a mouse, a touch panel, and the like, and an output device such as a display and the like.

The bus 106 is commonly connected to each of the above elements and transmits, for example, an address signal, a data signal, and various control signals.

The control device 100 according to the present embodiment acquires, for example, detection information obtained based on the TCD 11 provided in the gas processing system 1 and performs various controls. For example, the control device 100 acquires the detection information and outputs information concerning the state of the first container 5A1 and/or the third container 5A2. The information concerning the state of the container 5 may include, for example, information on whether or not the container 5 is saturated with gas. Specifically, the control device 100 may output information indicating that the vessel 5 is in a saturated state if the detection information indicates that it is breaking through. That is, in the case where the adsorption site by the MOF contained in the first container 5A1 is almost filled with the substance (molecule) constituting the first gas, further adsorption is difficult. The outflow of the first gas from the first container 5A1 may increase. Therefore, the amount of the first gas detected by the TCD 11 increases. Thereby, the breakthrough of the first gas is determined, so that it is estimated that the first container 5A1 is in a saturated state. The output destination may be, for example, a display device provided in the housing 10, a display device provided in the container 5, or the like. Further, the output destination may be an external server, a user terminal, or the like. Thereby, the user can know that the first container 5A1 and the like are in a saturated state.

Further, as described above, the control device 100 according to the present embodiment can control the opening and closing of the inlet valve 6 and the outlet valve 7 provided in the first line 21 and the second line 22. For example, the control device 100 according to the present embodiment closes the valve unit provided in the first line 21, when it is determined that the first container 5A1 is saturated based on the detection information. The valve unit provided on the first line 21 is closed. Thereby, the supply of gas to the saturated line can be automatically stopped. At that time, the control device 100 may control of opening the valve unit provided on the second line 22 before closing the valve unit. As a result, while starting the supply of gas to the third container 5A2 (and the fourth container 5B2) provided in the second line 22 which is not filled with gas, the first container 5A1 (and the second container 5B1) can be recovered.

Further, the control device 100 according to the present embodiment can also perform the above-mentioned MFC12 control and the like. The control device 100 can control, for example, the MFC 12 and thus control the flow rate of the mixed gas introduced into the gas treatment system 1. The MFC 12 is an example of a flow meter, for example, the flow meter may be a mass flow meter. The control device 100 may output information concerning the state of the container 5A and/or the container 5B based on the information concerning the flow rate indicated by, for example, the MFC 12. For example, when the flow rate shown in MFC 12 is lower than a predetermined flow rate, it may be information indicating that a breakthrough has occurred. Specifically, when the flow rate indicated by MFC12 is zero or a value close to zero, it can output information indicating that the MOF of at least one of the container 5A or the container 5B is in a closed state without adsorbing gas. Further, when the integrated value of the flow rate of the mixed gas calculated by the MFC 12 exceeds the threshold value based on the adsorption amount of the gas that can be collected in the container 5A and/or the container 5B, the control device 100 opens one of the valve units of the first line 21 or the second line 22, and may perform the control of closing the other valve unit. In such a control, the detection information based on TCD11 may be used together.

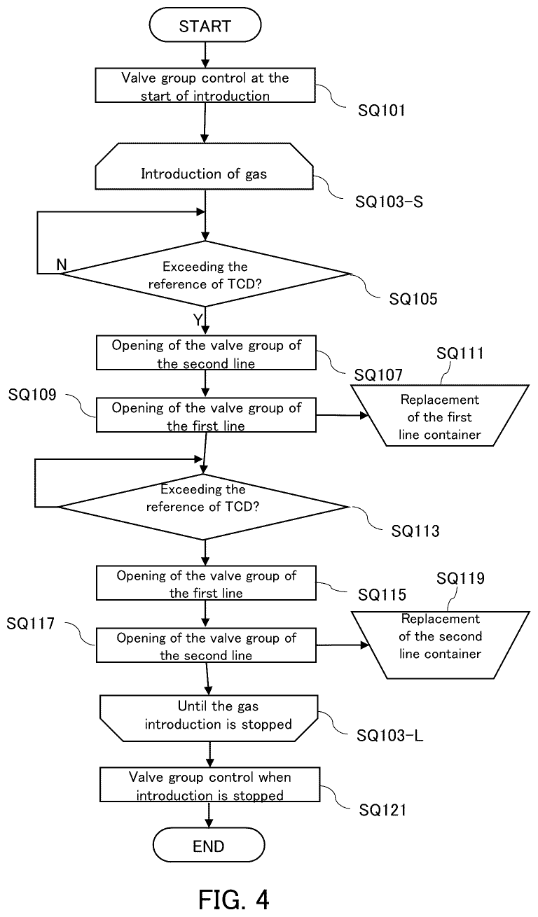

Next, an example of the flow of the gas treatment method using the gas treatment system 1 according to the present embodiment will be described. FIG. 4 is a flowchart showing an example of a flow of a gas treatment method using the gas treatment system 1 according to the present embodiment. The gas treatment system 1 according to the present embodiment introduces a mixed gas containing the first gas and the second gas from the inlet port 2A, collects the first gas in the container 5A (5A1, 5A2), collects the second gas in the container 5B (5B1, 5B2), and discharges the other gas from the outlet port 2B.

First, when introducing the mixed gas, the control device 100 controls the valve group of each line provided in the gas treatment system 1 (step SQ101). Specifically, the control device 100 controls opening the valve unit provided in the first line 21 and closing the valve unit provided in the second line 22. Then, the introduction of the mixed gas is started (step SQ103-S).

When the introduction of the mixed gas is started, the mixed gas flows through the first line 21. In the first container 5A1, the first gas contained in the mixed gas is collected by the first MOF. That is, the mixed gas containing the second gas, excluding the first gas, is discharged from the first container 5A1. Then, in the second container 5B1, the second gas is collected by the second MOF. A mixed gas excluding the first gas and the second gas is discharged from the second container 5B1.

Here, when it is detected in the TCD 11 provided on the downstream side of the first container 5A1 that it is exceeding the reference for detecting the first gas (step SQ105/Y), the control device 100 controls the opening of the valve unit provided on the second line 22 (step SQ107). Specifically, the control device 100 controls the opening of the inlet valves 6A2 and 6B2 and the outlet valves 7A2 and 7B2 shown in FIG. 2. Then, the control device 100 controls the closing of the valve unit provided in the first line 21 (step SQ109). Specifically, the control device 100 controls the closing of the inlet valves 6A1 and 6B1 and the outlet valves 7A1 and 7B1 shown in FIG. 2. Thereby, the flow path of the mixed gas in the gas treatment system 1 is switched from the first line 21 to the second line 22. Since the first container 5A1 and the second container 5B1 provided on the first line 21 are saturated with the first gas and the second gas, respectively, and are replaced with other containers (step SQ111). For example, by removing each container from the line attaching/detaching part 9, and connecting another container to the line attaching/detaching part 9, the container can be easily replaced.

Further, when the mixed gas is flowing through the second line 22, the first gas contained in the mixed gas is collected by the first MOF in the third container 5A2. That is, the mixed gas containing the second gas, excluding the first gas, is discharged from the third container 5A2. Then, in the fourth container 5B2, the second gas is collected by the second MOF. A mixed gas excluding the first gas and the second gas is discharged from the fourth container 5B2.

Here, when it is detected in the TCD 11 provided on the downstream side of the third container 5A2 that it is exceeding the reference for detecting the first gas (step SQ113/Y), the control device 100 controls the opening of the valve unit provided on the first line 21 (step SQ115). Specifically, the control device 100 controls the opening of the inlet valves 6A1 and 6B1 and the outlet valves 7A1 and 7B1 shown in FIG. 2. Then, the control device 100 controls the closing of the valve unit provided in the second line 22 (step SQ117). Specifically, the control device 100 controls the closing of the inlet valves 6A2 and 6B2 and the exit valves 7A2 and 7B2 shown in FIG. 2. Thereby, the flow path of the mixed gas in the gas treatment system 1 is switched from the second line 22 to the first line 21. Since the third container 5A2 and the fourth container 5B2 provided on the second line 22 are saturated with the first gas and the second gas, respectively, and are therefore replaced with other containers (step SQ119).

The processing of steps SQ105 to SQ119 is repeated until the introduction of the mixed gas is stopped (step SQ103-L). When the introduction of the mixed gas is stopped, the control device 100 may control the closing of the valves of all lines (step SQ121).

As described above, according to the gas treatment system 1 of the present embodiment, at least two gases among a mixed gas made of a plurality of substances are housed in each container, and are collected by MOF corresponding to the substance that composes the gas to be collected. At that time, a gas detector is provided on the downstream side of the container on the upstream side, and the breakthrough of the first gas that can be collected by the container is detected. The saturation state of the gas in the container can be determined. Thereby, in the collection of gas by the container using MOF, each of several desired gases can be easily separated, and can be obtained efficiently at the timing when it becomes saturated. Further, the collection capacity of the MOF housed in each container connected in series is set according to the ratio of the amount of each substance contained in the mixed gas, whereby, when the gas detector is installed on the downstream side of one of the containers in each line and the container that collects the gas to be detected becomes saturated, it can be saturated in other containers at the same time. Therefore, it is possible to efficiently recover each gas.

### <First Modification>

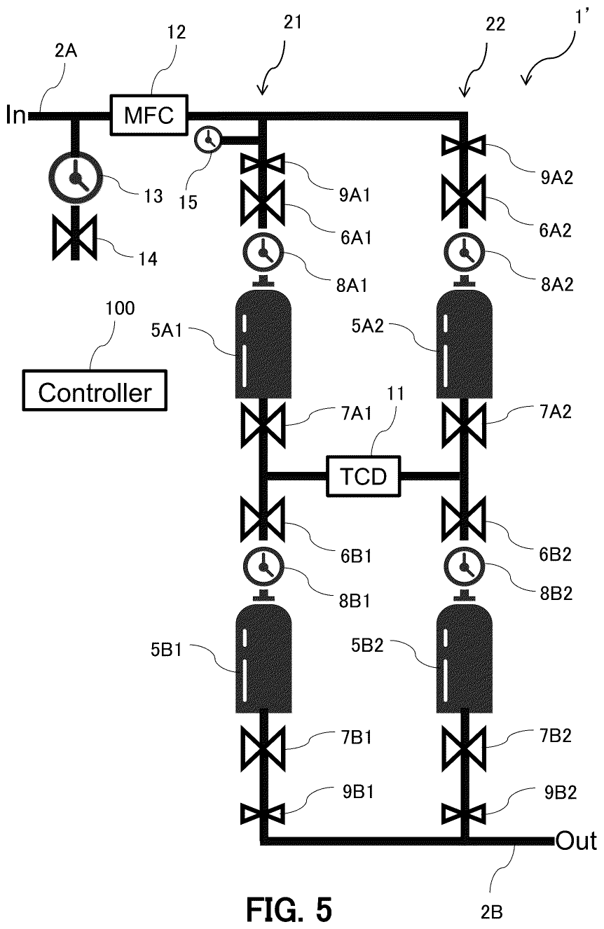

Next, the gas treatment system 1′ according to the first modification of the present embodiment will be described. FIG. 5 is a diagram showing a system configuration example of the gas treatment system 1′ according to the first modification of the present embodiment. In the gas treatment system 1′ shown in FIG. 5, in addition to the configuration of the gas treatment system 1 shown in FIG. 2, a pressure gauge 15 is provided on the inlet side of the first container 5A1 of the first line 21. The position where the pressure gauge 15 is provided is not particularly limited as long as it is on the inlet side (upstream side) of the container 5A1 in the first line 21.

The pressure gauge 15 can measure the pressure in the first line 21. For example, normally, the pressure gauge 15 can indicate the pressure of the gas when the gas is flowing through the first line 21. Meanwhile, if the state in the first container 5A1 is saturated or leaking, the pressure gauge 15 may indicate a pressure different from normal. Therefore, for example, the control device 100 may output information concerning the state of the first container 5A1 based on the pressure information obtained from the pressure gauge 15. Specifically, the control device 100 may output information concerning the state of the first container 5A1 based on the pressure information obtained from the pressure gauge 15 and the detection information (for example, breakthrough information) obtained based on the TCD 11. The pressure gauge 15 may measure the pressure of the line (flow path), unlike the pressure gauge 8 provided in each of the containers 5.

For example, if the first container 5A1 is in a saturated state (or in a nearly saturated state), the pressure in the first line 21 increases, and breakthrough may occur. Therefore, the control device 100 obtains pressure information corresponding to the saturated state of the first container 5A1 based on the pressure gauge 15. When breakthrough information indicating the breakthrough of the first gas is obtained from the first container 5A1 based on TCD11, it may output information indicating that the first gas is saturated in the first container 5A1.

Meanwhile, despite the breakthrough has occurred, when the pressure gauge 15 shows a pressure that does not correspond to the saturated state of the first container 5A1 (for example, when a rise in pressure is not seen), the gas adsorption rate is slow and the gas cannot be sufficiently collected in the MOF, so that there is a possibility that the first gas is leaking in the first container 5A1. Therefore, the control device 100 can obtain pressure information that does not correspond to the saturated state of the first container 5A1 based on the pressure gauge 15. When breakthrough information indicating the breakthrough of the first gas is obtained from the first container 5A1 based on TCD11, it can output information indicating that the first gas is leaking in the first container 5A1.

Further, even though the first gas has not been breaking through, when the pressure gauge 15 indicates that the pressure is increasing, it is considered that the first MOF housed in the first container 5A1 is clogged. Therefore, the control device 100 can obtain the pressure information that the first container 5A1 is rising based on the pressure gauge 15. When the detection information that the first gas is not breaking through is obtained from the first container 5A1 based on TCD11, it can output information indicating that the clogging occurs in the first container 5A1.

As described above, the control device 100 can output information concerning the state (saturation or abnormality) of the first container 5A1 based on the pressure information obtained from the pressure gauge 15 and the detection information obtained based on the TCD 11. By providing the pressure gauge 15, it is possible to more accurately grasp the state of adsorption derived from the MOF housed in each container 5. Thereby, the situation of the first container 5A1 can be accurately grasped. The pressure gauge 15 can be provided on the inlet side of the other container 5. In this case, by providing a TCD on the outlet side of the container 5, information concerning the state of the container 5 can be obtained similarly to the first container 5A1 described above. When the TCD 11 is not provided, for example, when the control device 100 obtains pressure information corresponding to the saturation of the first container 5A1 (for example, information indicating that the pressure indicated by the pressure gauge 15 exceeds a predetermined pressure) based on the pressure gauge 15, it may output information indicating that the first container 5A1 is in a state of breakthrough. That is, the detection information (breakthrough information) may be pressure information obtained from the pressure gauge. Further, the treatment in this modification can be applied to other containers 5.

### <Second Modification>

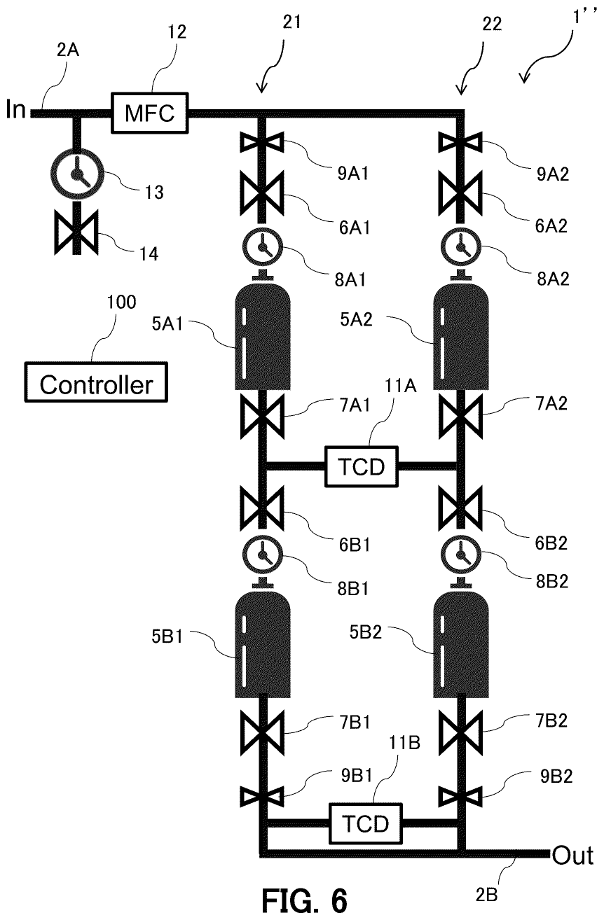

Next, the gas treatment system 1″ according to the second modification of the present embodiment will be described. FIG. 6 is a diagram showing a system configuration example of the gas treatment system 1′ according to the second modification of the present embodiment. In the gas treatment system 1″ shown in FIG. 6, TCD11A and 11B are provided in the space of the flow path on the outlet side of the first container 5A1 and the outlet side of the second container 5B1, respectively, in addition to the configuration of the gas treatment system 1 shown in FIG. 2. That is, in this modification, the TCD 11 is also provided on the outlet side of the second container 5B1 (5B2).

The control device 100 may output information concerning the state of the second container 5B1 based on the detection information, for example, based on TCD11B. Thereby, similarly to the first container 5A1, the second gas collection status can be grasped in the second container 5B1.

Further, the control device 100 may output information concerning the outflow of the mixed gas based on the detection information based on the TCD11A and the detection information based on the TCD11B. By providing the corresponding TCD 11 for each container 5, it is possible to grasp the outflow status of the gas that can be collected in each container. For example, when the harmful gas contained in the mixed gas is collected in each container, the gas that has not been collected in each of the TCD 11s and has flowed out of each container can be detected. In this case, the control device 100 may further control the closing of the valve unit of the line through which the mixed gas is flowing. This makes it possible to reduce the influence of leakage of harmful gas or the like to the outside, for example.

### <Third Modification>

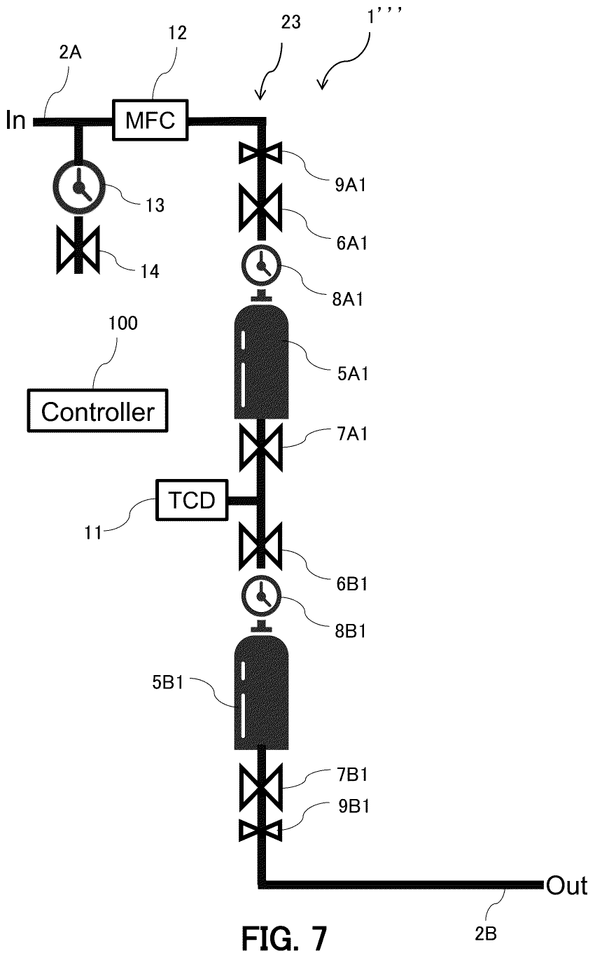

Next, the gas treatment system 1′″ according to the third modification of the present embodiment will be described. FIG. 7 is a diagram showing a system configuration example of a gas treatment system 1′″ according to a third modification of the present embodiment. In the gas treatment system 1′″ shown in FIG. 7, in the configuration of the gas treatment system 1 shown in FIG. 2, the lines are not parallel but are composed of only a single line. Even in such a case, it is possible to efficiently collect a specific gas as in the gas treatment system 1 of the above embodiment.

### <Fourth Modification>

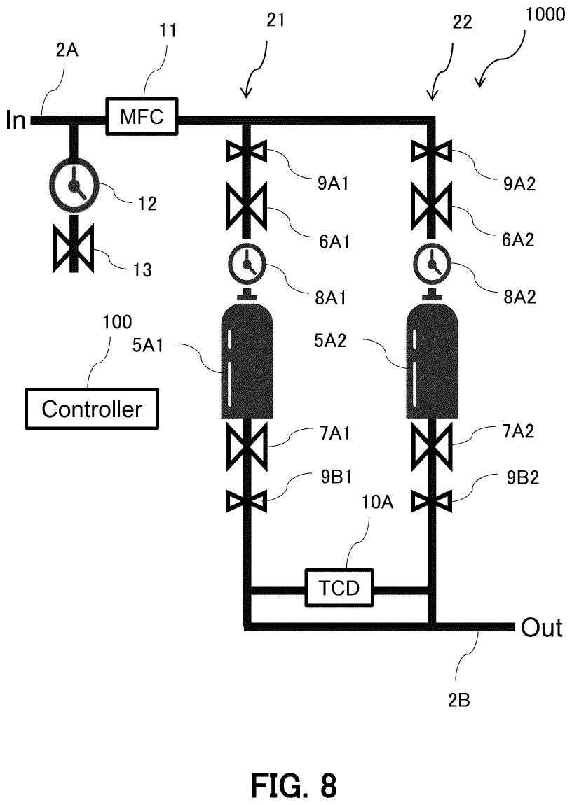

Next, the gas treatment system 1000 according to the fourth modification of the present embodiment will be described. FIG. 8 is a diagram showing a system configuration example of the gas treatment system 1000 according to the fourth modification of the present embodiment. The gas treatment system 1000 shown in FIG. 8 is an example in which one container 5 is provided in each line. In the gas treatment system 1000, for example, the gas introduced from the inlet port 2A may be a gas composed of a single substance, or may be the mixed gas shown in the above embodiment. In the container 5A, the introduced gas may be collected (that is, only the introduced gas is collected, and basically no gas flows from the outlet port 2B). Further, when a mixed gas is introduced, the MOF that adsorbs the substance constituting one kind of gas contained in the mixed gas may be contained in the container 5A. In this way, even if the containers 5 are not provided in series on one line, the TCD 11 is provided on the outlet side of the container 5A, so that it is possible to grasp the situation of the container 5A as shown in the above embodiment.

Further, in addition to the above-mentioned modification, the following modification can be reflected in the above-described embodiment. For example, the size of the holes in the MOF housed in the upstream container 5 connected in series may be larger than the size of the holes in the MOF housed in the downstream container 5. This makes it easier to prevent clogging due to molecules contained in the gas. Further, the MOF housed in the container 5 is not limited to powder, and may be, for example, a tableted MOF, a pellet-shaped MOF, a MOF impregnated and supported in a honeycomb base material, and the like. Considering the pressure loss when the flow rate is large, MOFs having a form or shape other than powder may be used. Further, for example, the MOF housed in the container 5 connected in series in each line may be the same type of MOF. That is, each container 5 may be configured so as to collect the same type of gas. Thereby, for example, in the filtering process of the mixed gas, the accuracy of the filter can be improved and the filtering ability can be improved. Further, the above-mentioned MFC may be provided not only on the upstream side of each line in the gas treatment system 1 but also on the downstream side of each line. In this case, the flow rate of the gas flowing from each line can be measured. Then, by comparing the difference between the total amount of gas obtained from the upstream MFC and the total amount of gas obtained from the downstream MFC with the estimated amount of gas collected in each container, it is possible to detect whether the gas is flowing out without being collected in each container. Further, the control device 100 may output the state of the container 5 based on the flow rate information obtained from the MFC instead of the TCD 11. That is, in the above embodiment, the control device 100 may determine and output whether or not a breakthrough has occurred based on whether or not the flow rate of the MFC has become a predetermined flow rate or less. Thereby, the state of the container 5 can be grasped by using the flow rate of the MFC. That is, the detection information (breakage information) may be information concerning the flow rate obtained from a flow meter such as an MFC.

The gas treatment system according to the present embodiment has been described above. Such a gas treatment system can be used, for example, to efficiently extract a desired gas from a mixed gas or to remove a gas that is harmful when the mixed gas is discarded. Further, after collecting the desired gas in a container, it is also possible to carry the container and use the collected gas for other purposes and the like. For example, if the container is capable of recovering carbon dioxide, carbonated water can be easily produced by setting the container in a carbonated water producing apparatus or the like. Further, as long as the container can recover oxygen, hydrogen, etc., these gases can be utilized in various industrial and personal applications. Such a gas treatment system realizes separation and reuse of gas resources and contributes to reduction of environmental load.

Although the preferred embodiments of the present disclosure have been described in detail with reference to the accompanying drawings, the technical scope of the present disclosure is not limited to such examples. It would be apparent to those skilled in the art that various modifications or amendments can be made within the scope of the technical ideas described in the claims. These are, of course, understood to belong to the technical scope of the present disclosure.

The device described herein can be realized as a single device, or can be realized by a plurality of devices (for example, a cloud server) which are partially or wholly connected by a network. For example, the controller 101 and the storage 103 of the control device 100 can be realized by different servers connected to each other by a network. The whole or part of the functions of the control device 100 can be exhibited in other terminals (not shown). Further, the information obtained from various measuring instruments and sensors provided in the gas processing system 1 and the container 5 and the like is acquired by the control device 100 provided outside the housing 10, and may control devices such as various valves from the control device 100.

The series of processes by the apparatus described herein can be realized by using any of software, hardware, and a combination of software and hardware. It is possible to create a computer program for realizing each function of the control device 100 according to the present embodiment and implement it on a PC or the like. It is also possible to provide a computer-readable recording medium in which such a computer program is stored. The recording medium is, for example, a magnetic disk, an optical disk, a magneto-optical disk, a flash memory, or the like. Further, the above computer program may be distributed, for example, via a network without using a recording medium.

Further, the processes described herein using the flowchart diagram do not necessarily have to be executed in the order shown in the drawings. Some processing steps can be performed in parallel. Further, additional processing steps may be adopted, and some processing steps may be omitted.

Further, the effects described herein are merely explanatory or exemplary and are not limited. That is, the techniques according to the present disclosure may have other effects apparent to those skilled in the art from the description herein, in addition to or in place of the above effects.

The following configurations also belong to the technical scope of the present disclosure.

### (Item 1)

A gas treatment system comprising:
a first container that houses a first porous metal-organic framework capable of collecting a first gas contained in a mixed gas flowing from an inlet side;
a second container that houses a second porous metal-organic framework capable of collecting a second gas contained in the mixed gas that flows in series with the first container;
a first gas detector that is provided in a space of the flow path on the downstream side of the first container as a detection target and can detect the first gas; and
a control device that outputs at least information concerning the state of the first container based on the detection information based on the first gas detector.

### (Item 2)

The gas treatment system according to item 1,
wherein the detection information comprises breakthrough information indicating that the first gas has been breaking through; and
wherein the control device outputs information concerning the state of the first container based on the breakthrough information.

### (Item 3)

The gas treatment system according to item 2,
wherein the first container comprises a valve for opening and closing the first container and an upstream side flow path of the first container;
wherein a pressure gauge is provided on the upstream side of the valve; and
wherein the control device outputs information concerning the state of the first container, based on the pressure information obtained from the pressure gauge provided in the flow path of the valve and the breakthrough information.

### (Item 4)

The gas treatment system according to item 3,
wherein, when the pressure information obtained from the pressure gauge provided in the flow path of the valve is information corresponding to the saturated state of the first gas in the first container, the control device outputs information indicating that the first gas is saturated in the first container.

### (Item 5)

The gas treatment system as in item 3 or 4,
wherein, when the pressure information obtained from the pressure gauge provided in the flow path of the valve does not correspond to the saturated state of the first gas in the first container, the control device outputs information indicating that an abnormality has occurred in the first container.

### (Item 6)

The gas treatment system as in one of items 1 to 5,
wherein a housing capacity of the first porous metal-organic framework in the first container and a housing capacity of the second porous metal-organic framework in the second container are set according to the composition ratio of the first gas and the second gas contained in the mixed gas.

### (Item 7)

The gas treatment system as in one of items 1 to 6,
wherein the first gas detector is provided in at least one of a space of the flow path flowing between the first container and the second container and a downstream side of the second container.

### (Item 8)

The gas treatment system according to item 7,
wherein the control device outputs information concerning the outflow of the mixed gas, based on at least the detection information based on the first gas detector, and the detection information based on a second gas detector that is provided on the downstream side of the second container separately from the first gas detector; and capable of detecting the second gas.

### (Item 9)

The gas treatment system as in one of items 1 to 8,
wherein a flow meter is provided in the flow path through which the first container flows; and
wherein the control device outputs information concerning the state of the first container based on the information concerning the flow rate obtained from the flow meter.

### (Item 10)

A gas treatment system comprising:
a first container that houses a first porous metal-organic framework capable of collecting a first gas contained in a mixed gas flowing from an inlet side; and
a second container that houses a second porous metal-organic framework capable of collecting a second gas contained in a mixed gas flowing from an outlet side of the first container,
wherein a housing capacity of the first porous metal-organic framework in the first container and a housing capacity of the second porous metal-organic framework in the second container are set according to the composition ratio of the first gas and the second gas contained in the mixed gas.

### (Item 11)

The gas treatment system according to item 10, further comprising a control device,
wherein the control device outputs information concerning the state of at least one of the first container and the second container, based on the detection information of gas flowing through the first container and the second container.

### (Item 12)

The gas treatment system according to item 11,
wherein the gas detection information comprises information obtained by a gas detector provided in a flow path on the downstream side of the first container.

### (Item 13)

The gas treatment system according to item 11 or 12,
wherein the gas detection information comprises information concerning the flow rate obtained from the flow meter of the flow path flowing through the first container and the second container.

### (Item 14)

The gas treatment system as in one of items 11 to 13,
wherein the first container includes a valve for opening and closing the first container and an upstream side flow path of the first container, and
wherein the gas detection information comprises pressure information obtained from a pressure gauge provided in an upstream side flow path of the valve of the first container.

### (Item 15)

The gas treatment system as in any of items 1 to 9 or 11 to 14,
which further comprises a first valve unit for opening and closing a flow path of a first line including the first container and the second container,
wherein the control device performs a control of putting the first valve unit into a closed state when it is determined that at least one of the first container and the second container is saturated based on the detection information.

### (Item 16)

The gas treatment system according to item 15, further comprising:
a third container that houses the first porous metal-organic framework; and
a fourth container that houses the second porous metal-organic framework,
wherein the third container and the fourth container comprise a second line provided in parallel with the first container and the second container,
and further comprises a second valve unit for opening and closing the flow path of the second line,
when it is determined that the second valve unit is in the closed state and at least one of the first container and the second container is saturated, the control device performs a control of putting the second valve unit into an open state, and then performs a control of putting the first valve unit into a closed state.

### (Item 17)

The gas treatment system according to one of items 1 to 16,
wherein the information concerning the state of the first container comprises at least one of information indicating that the first gas is saturated in the first container and information indicating that an abnormality has occurred in the first container.

### (Item 18)

The gas treatment system according to one of items 1 to 17,
wherein at least one of the first container and the second container is detachably provided with respect to a line comprising the flow path of the first container and the second container, and
a valve for opening and closing the flow path between the corresponding container and the line, and a pressure gauge provided on the side of the corresponding container rather than the valve and measuring the pressure of the corresponding container is provided on the corresponding container.

### (Item 19)

The gas treatment system as in one of items 1 to 18,
wherein the first porous metal-organic framework housed in the first container can collect only the first gas; and
wherein the second porous metal-organic framework housed in the second container can collect only the second gas.

### (Item 20)

A gas treatment method using a gas treatment device which comprises a first container that houses a first porous metal-organic framework capable of collecting a first gas, and a second container that flows in series with the first container and houses a second porous metal-organic framework capable of collecting a second gas, the method comprising the steps of:
flowing a mixed gas containing at least a first gas and a second gas from an inlet side of the container on the upstream side of either the first container or the second container,
measuring the flow rate of the first gas in the space of the flow path on the downstream side of the first container by the first gas detector, and
outputting information concerning the state of the first container by a control device, based on the detection information obtained based on the flow rate of the first gas measured by the first gas detector.

### (Item 21)

A gas treatment method using a gas treatment device which comprises a first container that houses a first porous metal-organic framework capable of collecting a first gas, and a second container that flows with the first container and houses a second porous metal-organic framework capable of collecting a second gas, the method comprising the steps of:
setting the housing capacity of the first porous metal-organic framework in a first container and the housing capacity of the second porous metal-organic framework in a second container according to the composition ratio of the first gas and the second gas contained in the mixed gas; and
allowing the mixed gas to flow from an inlet side of the first container.

### (Item 22)

A control device comprising:
a first container that houses a first porous metal-organic framework capable of collecting a first gas; and
a second container that flows in series with the first container and houses a second porous metal-organic framework capable of collecting a second gas,
wherein after the mixed gas that houses at least the first gas and the second gas, which is circulated from an inlet side of the first container, is circulated to the first container,
the space of the downstream side flow path of the first container is provided as a detection target, and information concerning the status of the first container is outputted based on the detection information obtained from the first gas detector capable of detecting the first gas.

### DESCRIPTION OF REFERENCE NUMERALS

1: gas treatment system
2A: inlet port
2B: outlet port
4: pressure sensor
5: container
5A1: first container
5B1: second container
5A2: third container
5B2: fourth container
6: inlet side valve
7: outlet side valve
8: pressure gauge
11: TCD
12: MFC
100: control device

1. A gas treatment system comprising:
a first container that houses a first porous metal-organic framework capable of collecting a first gas contained in a mixed gas flowing from an inlet side;
a second container that houses a second porous metal-organic framework capable of collecting a second gas contained in the mixed gas that flows in series with the first container;
a first gas detector that is provided in a space of the flow path on the downstream side of the first container as a detection target and can detect the first gas; and
a control device that outputs at least information concerning the state of the first container based on the detection information based on the first gas detector.

2. The gas treatment system according to claim 1,
wherein the detection information comprises breakthrough information indicating that the first gas has been breaking through; and
wherein the control device outputs information concerning the state of the first container based on the breakthrough information.

3. The gas treatment system according to claim 2,
wherein the first container comprises a valve for opening and closing the first container and an upstream side flow path of the first container;
wherein a pressure gauge is provided on the upstream side of the valve; and
wherein the control device outputs information concerning the state of the first container, based on the pressure information obtained from the pressure gauge provided in the flow path of the valve and the breakthrough information.

4. The gas treatment system according to claim 3,
wherein, when the pressure information obtained from the pressure gauge provided in the flow path of the valve is information corresponding to the saturated state of the first gas in the first container, the control device outputs information indicating that the first gas is saturated in the first container.

5. The gas treatment system as in claim 3,
wherein, when the pressure information obtained from the pressure gauge provided in the flow path of the valve does not correspond to the saturated state of the first gas in the first container, the control device outputs information indicating that an abnormality has occurred in the first container.

6. The gas treatment system as in claim 1,
wherein a housing capacity of the first porous metal-organic framework in the first container and a housing capacity of the second porous metal-organic framework in the second container are set according to the composition ratio of the first gas and the second gas contained in the mixed gas.

7. The gas treatment system as in claim 1,
wherein the first gas detector is provided in at least one of a space of the flow path flowing between the first container and the second container and a downstream side of the second container.

8. The gas treatment system according to claim 7,
wherein the control device outputs information concerning the outflow of the mixed gas, based on at least the detection information based on the first gas detector, and the detection information based on a second gas detector that is provided on the downstream side of the second container separately from the first gas detector; and capable of detecting the second gas.

9. The gas treatment system as in claim 1,
wherein a flow meter is provided in the flow path through which the first container flows; and
wherein the control device outputs information concerning the state of the first container based on the information concerning the flow rate obtained from the flow meter.

10. A gas treatment system comprising:
a first container that houses a first porous metal-organic framework capable of collecting a first gas contained in a mixed gas flowing from an inlet side; and
a second container that houses a second porous metal-organic framework capable of collecting a second gas contained in a mixed gas flowing from an outlet side of the first container,
wherein a housing capacity of the first porous metal-organic framework in the first container and a housing capacity of the second porous metal-organic framework in the second container are set according to the composition ratio of the first gas and the second gas contained in the mixed gas.

11. The gas treatment system according to claim 10, further comprising a control device,
wherein the control device outputs information concerning the state of at least one of the first container and the second container, based on the detection information of gas flowing through the first container and the second container.

12. The gas treatment system according to claim 11,
wherein the gas detection information comprises information obtained by a gas detector provided in a flow path on the downstream side of the first container.

13. The gas treatment system according to claim 11,
wherein the gas detection information comprises information concerning the flow rate obtained from the flow meter of the flow path flowing through the first container and the second container.

14. The gas treatment system as in claim 11,
wherein the first container includes a valve for opening and closing the first container and an upstream side flow path of the first container, and
wherein the gas detection information comprises pressure information obtained from a pressure gauge provided in an upstream side flow path of the valve of the first container.

15. The gas treatment system as in claim 1,
which further comprises a first valve unit for opening and closing a flow path of a first line including the first container and the second container,
wherein the control device performs a control of putting the first valve unit into a closed state when it is determined that at least one of the first container and the second container is saturated based on the detection information.

16. The gas treatment system according to claim 15, further comprising:
a third container that houses the first porous metal-organic framework; and
a fourth container that houses the second porous metal-organic framework,
wherein the third container and the fourth container comprise a second line provided in parallel with the first container and the second container,
and further comprises a second valve unit for opening and closing the flow path of the second line,
when it is determined that the second valve unit is in the closed state and at least one of the first container and the second container is saturated, the control device performs a control of putting the second valve unit into an open state, and then performs a control of putting the first valve unit into a closed state.

17. The gas treatment system according to claim 1,
wherein the information concerning the state of the first container comprises at least one of information indicating that the first gas is saturated in the first container and information indicating that an abnormality has occurred in the first container.

18. The gas treatment system according to claim 1,
wherein at least one of the first container and the second container is detachably provided with respect to a line comprising the flow path of the first container and the second container, and
a valve for opening and closing the flow path between the corresponding container and the line, and a pressure gauge provided on the side of the corresponding container rather than the valve and measuring the pressure of the corresponding container is provided on the corresponding container.

19. The gas treatment system as in claim 1,
wherein the first porous metal-organic framework housed in the first container can collect only the first gas; and
wherein the second porous metal-organic framework housed in the second container can collect only the second gas.

20. A gas treatment method using a gas treatment device which comprises a first container that houses a first porous metal-organic framework capable of collecting a first gas, and a second container that flows in series with the first container and houses a second porous metal-organic framework capable of collecting a second gas, the method comprising the steps of:
flowing a mixed gas containing at least a first gas and a second gas from an inlet side of the container on the upstream side of either the first container or the second container,
measuring the flow rate of the first gas in the space of the flow path on the downstream side of the first container by the first gas detector, and
outputting information concerning the state of the first container by a control device, based on the detection information obtained based on the flow rate of the first gas measured by the first gas detector.

21. A gas treatment method using a gas treatment device which comprises a first container that houses a first porous metal-organic framework capable of collecting a first gas, and a second container that flows with the first container and houses a second porous metal-organic framework capable of collecting a second gas, the method comprising the steps of:
setting the housing capacity of the first porous metal-organic framework in a first container and the housing capacity of the second porous metal-organic framework in a second container according to the composition ratio of the first gas and the second gas contained in the mixed gas; and
allowing the mixed gas to flow from an inlet side of the first container.

22. (canceled)
